(19) United States
(12) Patent Application Publication
(10) Pub. No.: US 2008/0022860 A1
(43) Pub. Date: Jan. 31, 2008

(54) Device for Producing a Milk Emulsion and Coffee Machine Comprising One Such Device

(76) Inventors: Romain Turpin, Caen (FR); Nicolas Bazin, Herouville Saint Clair (FR)

Correspondence Address: YOUNG & THOMPSON, 745 SOUTH 23RD STREET, 2ND FLOOR, ARLINGTON, VA, 22202, US

(21) Appl. No.: 11/661,828

(22) PCT Filed: Sep. 1, 2005
(86) PCT No.: PCT/FR05/02192

§ 371 Date: Mar. 5, 2007

(30) Foreign Application Priority Data
Sep. 10, 2004 (FR) 0409625

(51) Int. Cl. A47J 31/46; A47J 31/44

(52) U.S. Cl. 99/290; 99/323.3

(57) ABSTRACT

A device for producing a milk emulsion includes: a steam injection conduit (10), a milk conduit (15), an air conduit (16) which opens into a suction chamber (3), and an air control element (25) designed to adjust the air flow passing through the air conduit. The device also includes a tubular segment (14) having an outer surface (24) at which the air conduit (16) opens. The air control element (25) includes first and second sealing elements (29, 30) provided on the outer surface (24). In addition, the air control element (25) can move between (i) a cappuccino position in which the opening (22) of the air conduit (16) communicates with the atmosphere and (ii) a hot milk position in which the first and second sealing elements define a sealed space containing the air conduit opening. A coffee machine including one such device is also disclosed.

This invention relates to a device for producing a milk emulsion that comprises a body including:
A steam injection hose that empties into an intake chamber and that is designed to be connected to a steam source;
A milk hose that is linked to the intake chamber and designed to be connected to a container that holds milk;
An air hose that is linked to said intake chamber and that has an opening through which ambient air is designed to be drawn in;
An emulsion chamber that has an outlet through which the formed emulsion is evacuated; and
An air control that is suitable for regulating the air flow circulating in the air hose.

In such a device, the injection of the steam into the intake chamber makes it possible to draw in milk and air by the Venturi effect and to heat the formed mixture. The emulsion of air and milk comes in the form of a more or less thick froth according to the configuration of the emulsion chamber that is downstream from the intake chamber but primarily based on the amount of air that is drawn in relative to the amount of milk. A device of this type is known from the document U.S. Pat. No. 5,738,002, in which an adjusting screw is provided to adjust the flow rate of air that is drawn in. Because of the gaseous nature of the air, which is different from that of the milk, the adjustment of the air flow makes it necessary to produce a passage that is small and calibrated precisely.

By completely shutting off the air hose, this type of device also makes it possible to prepare hot milk that comes in liquid form, i.e., that has almost no froth, to prepare coffee with milk, also called latte, in contrast to cappuccino, in which the milk comes in the form of froth.

The shutting-off of the air hose with a screw as described in the document U.S. Pat. No. 5,738,002 makes it necessary to carry out several turns until the locking of the screw is achieved, which leads to a suitable loss of adjustment for the preparation of a milk froth and consequently is not very practical for passing from a cappuccino position to a hot milk position.

The object of this invention is to produce a device of the above-mentioned type that makes it possible for the user to pass easily and quickly from one configuration of the device that makes it possible to produce a milk froth to a configuration that makes it possible to produce hot milk, and conversely, without the return to a configuration for production of a milk emulsion requiring tedious adjustment.

For this purpose, this invention has as its object a device for preparing milk emulsion of the above-mentioned type, characterized in that it comprises a tubular portion that has an outside surface in which the opening of the air hose is arranged, the control comprises first and second sealing means that are arranged on the outside surface of the tubular portion, and said air control can be moved between one position, called cappuccino position, for which the opening of the air hose communicates with the atmosphere, and one position, called hot milk position, for which the first and second sealing means define an airtight space in which the opening of the air hose is arranged.

Thanks to the first and second sealing means of the air control, an even relatively slight movement of this control makes it possible to pass easily from one configuration in which the air hose is shut off in an airtight manner, to a configuration in which it freely communicates with the atmosphere; the air hose then can have a calibrated cross-section based on the milk flow rate that is obtained under normal conditions of use, such that at the outlet of the device, a milk froth of satisfactory quality is obtained. In addition, such an air control can be made with a small number of parts without profoundly modifying either the structure or the space occupied by the device.

In preferred embodiments of the invention, there is also recourse to one and/or to the other of the following arrangements:
At least the second sealing means is integral with the air control and moved with the latter;
The opening of the air hose comprises a calibrated groove that extends on both sides of the second sealing means when the air control is in cappuccino position and included in the airtight space when the air control is in hot milk position;
The calibrated groove has a cross-section that increases toward the air hose, the air control being suitable for taking at least a first and second cappuccino position for which the second sealing means is respectively positioned at a first and second cross-section of the groove, whereby said second cross-section has an area that is more than the first cross-section;
The outside surface of the tubular portion is cylindrical and the air control is a ring mounted to rotate around the longitudinal axis of said tubular portion;
The air control rotates at most 180° between its cappuccino position and its hot milk position;
The second sealing means extends in an inclined plane relative to the longitudinal axis of the tubular portion, and the air control is guided in rotation relative to the tubular portion;
The second sealing means extends in a plane that is transverse to the longitudinal axis of the tubular portion, and the air control is guided in a helical movement relative to the tubular portion;
At least one of the first and second sealing means is an annular collar that is made of the same material as the air control.

Furthermore, the invention also has as its object an espresso-type coffeemaker that comprises a steam generator and a tube that has a first end that is connected to the steam generator and a second end that forms a steam discharge, characterized in that a milk emulsion production device as defined above is arranged at the second end of the steam discharge tube.

Other characteristics and advantages of the invention will emerge during the following description, given by way of nonlimiting example, in reference to the accompanying drawings, in which:

FIG. 1 is a cutaway view of a device for milk emulsion production according to a first embodiment of the invention, in which an air control is in a so-called cappuccino position;

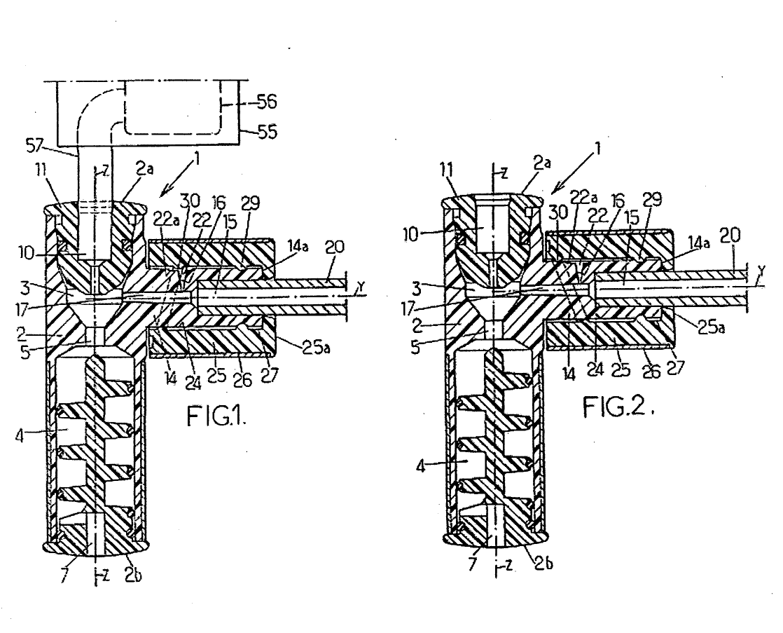

FIG. 2 is a view analogous to FIG. 1, in which the air control is in a so-called hot milk position;

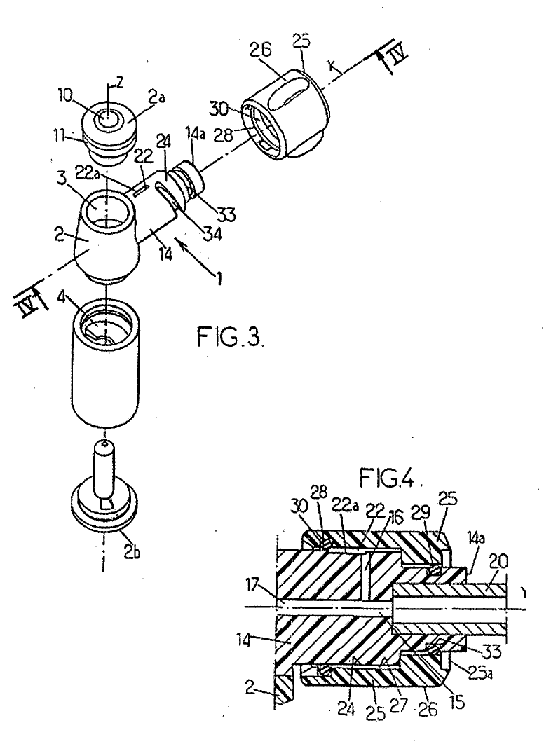

FIG. 3 is an exploded perspective view of a second embodiment;

FIG. 4 is a partial cutaway view along line IV-IV of FIG. 3.

In the different figures, identical references were retained to designate identical or similar elements.

FIG. 1 shows a device for milk emulsion production 1 that comprises a body 2 that extends longitudinally along a central axis Z and is cylindrical overall. The body 2 comprises an intake chamber 3 and a secondary emulsion chamber 4 that are coaxial to the central axis Z. The intake chamber 3 and the emulsion chamber 4 are arranged consecutively along the central axis Z and are linked to one another via a passage 5.

The device 1 is designed to be mounted on an espresso-type coffeemaker such that the intake chamber 3 is located above the emulsion chamber 4, i.e., with a central axis Z that is approximately vertical to promote the flow from the intake chamber 3 to the emulsion chamber 4.

The body 2 comprises a steam injection hose 10 that extends from an upper end 2a of the body 2 up to the intake chamber 3. The upper portion of the steam injection hose 10 has a diameter that is suitable for inserting in the latter the end of a steam discharge tube of the espresso machine, and a lower portion that empties into the intake chamber 3, which has a small diameter and makes it possible to inject steam along the central axis Z. The steam injection hose 10 is formed in a plug 11 that is inserted in a removable and airtight manner into the body 2, so as to facilitate in particular the cleaning of the intake chamber 3.

The body 2 comprises a tubular arm 14 that extends radially relative to the central axis Z and is formed in a single part with the body. The arm 14 comprises a milk hose 15, an air hose 16 and a feed hose 17 that extend up to the intake chamber 3. It will be noted that the tubular arm 14 forms a tubular portion of the device 1, having a longitudinal axis Y and an outside cylindrical surface 24 in the embodiments shown.

The milk hose 15 extends radially from the end 14a of the arm 14 to the intake chamber 3 up to a point where the air hose 16 empties. A first portion of the milk hose 15 that is adjacent to the end 14a of the arm has an inside diameter that is suitable for receiving, by shrinking-on, one end of a tube 20, whereby the other end of this tube (not shown) is immersed in a container that holds milk.

The air hose 16 extends perpendicularly relative to the milk hose 15 from an opening 22 that is arranged in the outside face 24 of the tubular arm 14, up to the milk hose 15. The air hose 16 makes it possible to draw in ambient air thanks to a selective linking, as will be explained below, of the opening 22 to the atmosphere. The air hose 16 has a cross-section that decreases toward the milk hose 15 so as to limit the flow rate of the drawn-in air.

In the embodiments shown, the opening 22 of the air hose 16, a better view of, which is given in FIG. 3, comprises a groove 22a that extends along the longitudinal axis Y of the tubular arm 14.

The feed hose 17 extends in the extension of the milk hose 15 from the intersection between the air hose 16 and the air hose 15 and links these hoses 15 and 16 with the intake chamber 3 into which the milk and the air are drawn simultaneously by the Venturi effect. The feed hose 17 empties perpendicularly into the steam injection hose 10 so as to promote the intake of milk and air and the mixture with the injected steam.

The mixture that is formed in the intake chamber 3 is transferred through the passage 5 that is formed in the lower portion of the latter toward the secondary emulsion chamber 4, then is evacuated from the device 1 via an output orifice 7 that is made at a lower end 2b of the body 2.

According to a first preferred embodiment that is shown in FIGS. 1 and 2, an air control 25 is mounted to rotate around the longitudinal axis Y on the tubular arm 14. The air control 25 has an outside face 26 that is suitable for being manipulated with the fingers and an inside face 27 that surrounds the cylindrical outside surface 24 of the arm 14.

In this first embodiment, FIGS. 1 and 2, the inside face 27 of the air control 25 has a first collar 29 and a second collar 30 that are circular and project toward the center of the tubular arm 14. These first and second collars (29, 30) respectively form a first and a second air-sealing means between the outside surface 24 of the arm 14 and the inside face 27 of the air control 25. In this first embodiment where the collars (29, 30) are made of the same material as the air control 25, it may be preferable to produce the latter in a plastic material that has a certain elasticity so that the collars (29, 30) are slightly deformed upon contact with the tubular arm 14 and thus conform in shape, in an airtight manner, to the outside surface 24 of this arm.

The first collar 29 extends in a plane that is transverse to the longitudinal axis Y and has a radial cross-section that is suitable for working with a circular groove that is formed in the outside face 24 of the arm 14 and that extends in the same transverse plane as the collar 29. Thus, the first collar 29 performs, in addition to its sealing function, a function of guiding in rotation the air control 25 around the longitudinal axis Y of the arm 14. In this example, the air control 25 is therefore movable only in rotation, with the exclusion of any possibility of sliding along the longitudinal axis Y.

The second collar 30 is formed analogously to the first collar 29 but has a lower height so as to seal tightly the outside face 24 of the arm 14 without exerting excessive friction force.

Furthermore, the second collar 30 extends in an inclined plane relative to the longitudinal axis Y of the arm 14 and not in a transverse plane like the first collar 29. This inclined arrangement makes it possible to move the second collar 30 longitudinally along the outside surface 24 of the arm under the effect of the rotation of the air control 25 around this arm and consequently to vary the distance that separates the first and second collars (29, 30) for a given radial direction of the tubular arm 14. For example, by carrying out a rotation of 180° of the air control 25 from the position that is shown in FIG. 1 to the position that is shown in FIG. 2, the distance between the first collar 29 and the second collar 30 increases when the radial direction of the tubular arm 14 that comprises the air hose 16 is considered.

Outside of the first and second collars (29, 30), the outside surface 24 of the tubular arm 14 is separated from the inside face 27 of the air control 25 by a space in which the air can circulate. Thus, the space between the tubular arm 14 and the air control 25 that extends from the second collar 30 toward the cylindrical body 2, i.e., extending to the left of the second collar 30 in FIGS. 1 and 2, freely communicates with the ambient air. The space included between the tubular arm 14 and the air control 25, which extends from the first collar 29 toward the free end 14a of the arm, could also freely communicate with the ambient air. However, in the first embodiment, the air control 25 comprises a radial inside flange 25a that conforms to the shape of the end 14a of the tubular arm and increases the airtightness.

The opening 22 of the air hose 16 is arranged longitudinally in the outside surface 24 of the arm 14 in a suitable position so that the opening 22 at least partly communicates with the ambient air when the air control 25 is in a first position, said cappuccino position, shown in FIG. 1, and so that the opening 22 is in the airtight space that is delimited by the first and second collars (29, 30), the outside surface 24 of the tubular arm 14 and the inside face 27 of the air control 25, when said air control is in a second position, said hot milk position, shown in FIG. 2.

In the position that is shown in FIG. 1, the second collar 30 is arranged opposite to the groove 22a of the opening 22, i.e., opposite to a zone of slight depth, and forms with this groove 22a an air passage of reduced cross-section, approximately equal to the cross-section of the groove 22a at the second collar 30, which makes it possible to calibrate the flow rate of air that is drawn in.

However, the opening 22 of the air hose 16 could be formed by a simple circular hole that is arranged so that the first and second collars (29, 30) are located on both sides of the opening 22 when the air control is in hot milk position, and so that the first and second collars (29, 30) are both located on the same side of the opening 22, without partially covering this opening, when the air control 25 is in cappuccino position. The fact of providing a groove 22a, however, offers advantages, in particular during the production. Actually, when these are injection-molded plastic parts, it is easier to produce a calibrated passage with a relief of the mold of low height that forms a groove than with a relief or an insert that comes in the form of a fine needle.

In addition, in a variant that is not shown, it may be advantageous to provide that the groove 22a have a cross-section that increases from its distant end of the air hose 16 up to its end that is adjacent to the air hose 16, for example, by gradually increasing the depth and/or the width of the groove 22a. The air control 25 is then adapted to take on several positions, at least two, for which the second collar 30 is positioned longitudinally at the level of various sections of the groove 22a that each have a different area. Different cappuccino positions that each correspond to a different air flow are thus obtained, which makes it possible to obtain different amounts of froth. These different cappuccino positions, just as the hot milk position or a single cappuccino position, can be referenced by pictograms that are inscribed on the outside face 26 of the air control 25 that the user can easily relate to a reference that is placed on the cylindrical body 2.

In the second embodiment shown in FIGS. 3 and 4, the emulsion production device 1 comprises, analogously to the first embodiment, a tubular arm 14 in which the milk hose 15, air hose 16 and feed hose 17 are formed and a movable air control 25 that also comes in the form of a ring that surrounds the outside cylindrical surface 24 of the arm 14.

In this second embodiment, the first and second sealing means are formed by O-ring seals (29, 30) that are placed in a plane that is transverse to the longitudinal axis Y of the tubular arm 14, which ensure sealing between the outside surface 24 of the arm 14 and the inside face 27 of the air control 25.

The first seal 29 is housed in an annular groove 33 that is formed in the outside surface 24 of the tubular arm 14 and is close to the end 14a of the latter. The first sealing means that is formed by the O-ring seal 29 is therefore immobile relative to the arm 14.

The second sealing means formed by the second O-ring seal 30 is housed in an annular groove 28 that is formed in the inside face of the air control 25. The second sealing means that is formed by the O-ring seal 30 is therefore made integral with the air control 25.

The tubular arm 14 also comprises a groove 34, visible in FIG. 3, which extends helically in the outside surface 24 over an angular sector of about 120°. The air control 25 comprises a piece, not visible in FIGS. 3 and 4, extending radially from the inside face 27 toward the longitudinal axis Y. When the ring 25 that forms the air control is mounted on the tubular arm 14, the piece works with the groove 34 such that a rotation of the air control that is carried out by the user entrains a combined movement for translating this control 25 along the tubular arm 14. This helical guiding between the air control 25 and the tubular arm 14 therefore entrains a movement of the second O-ring seal 30 along the outside surface 24 between two end positions that are defined by the amplitude of the combined movement of rotation and translation that the helical groove 34 allows.

The configuration that is shown in FIG. 4 corresponds to the hot milk position of the air control 25 in which the latter is located close to the body 2. The opening 22 of the air hose 16 that comprises a groove 22a, analogous to that of the first embodiment, is arranged in the outside surface 24 of the arm 14 so as to be located between the first and second O-ring seals (29, 30) for this hot milk position, i.e., in a configuration where the air hose 16 empties into an airtight space.

Further, the helical groove 34 is suitable for positioning the second O-ring seal 30 opposite the groove 22a when a rotation of about 120° is carried out in a counterclockwise direction of the air control 25 from its hot milk position that is shown in FIG. 4 to a cappuccino position, not shown, in which the air hose 16 can draw in ambient air through the calibrated passage that is formed by the groove 22a and the second O-ring seal 30. Just as in the first embodiment, the hot milk positions and the cappuccino position(s) can easily be referenced using pictograms that are formed on the outside face 26 of the air control 25.

The milk emulsion device 1 is mounted on an espresso-type coffeemaker 55, partially shown in FIG. 1, which comprises a steam generator 56 and a tube 57 that is connected to the steam generator. The tube 57 has an end that forms a steam discharge on which the milk emulsion device 1 is mounted. This assembly can be permanent or removable and, in this latter case, the device 1 forms an accessory of the coffeemaker.

To use the device, the user places the air control 25 into the appropriate position and actuates a control for steam production of the coffeemaker 55 making it possible to release the pressurized steam, whereby it is understood that the steam injection hose 10 of the device 1 is mounted on the steam discharge tube 57 of the machine and that the milk intake hose 15 is connected to a milk reserve, for example via a flexible tube 20 that is immersed in a container.

The appropriate position of the air control 25, i.e., a hot milk position or a cappuccino position, optionally selected from among various cappuccino positions, is easily done by turning the air control 25 at least one half-turn by placing an appropriate pictogram opposite an associated reference. The movement imparted to the air control 25, whether this be a pure rotation as in the first embodiment or a helical movement as in the second embodiment, makes it possible to move the second sealing means 30 so that the air hose 16 communicates with the atmosphere for the cappuccino position or so that the air hose 16 empties into an airtight space relative to the atmosphere for the hot milk position.

In cappuccino position, the partial vacuum created in the intake chamber 3 by the injection of the steam entrains an intake both of milk and air by the hoses 15 and 16, a pre-mixing of the air and the milk in the feed hose 17, an intake and a first mixing of the milk, the air and the steam in the intake chamber 3, followed by an emulsion in the secondary chamber 4 and a flow toward the outlet 7 of the device where a good-quality froth is obtained because of the calibration of the air flow.

In hot milk position, the air hose 16 is shut off so that only the milk is drawn into the intake chamber 3. This milk is reheated by contact with the steam that is injected into the intake chamber 3, then during the passage into the secondary chamber 4 where the major portion of the steam condenses, so that the hot milk that flows through the outlet 7 comprises virtually no froth.

The embodiments that are described above are not limiting. It is possible in particular to provide that the two sealing means be immobile relative to the tubular arm 14. It is also possible that the communication with the ambient air of the opening 22 of the air hose 16 be done by a groove that is formed in the inside face 27 of the air control 25 that is selectively positioned on both sides of the second sealing means 30, or so as to be outside of the space between the sealing means (29, 30), owing to the movement of the air control 25. Further, the sealing means (29, 30) could be made differently, for example by direct contact of a cylindrical or grooved portion of the inside face 27 of the air control 25 with an additional portion of the outside surface 24 of the tubular arm 14.

1. Device for producing a milk emulsion that comprises a body (2) including:
A steam injection hose (10) that empties into an intake chamber (3) and that is designed to be connected to a steam source;
A milk hose (15) that is linked to the intake chamber (3) and designed to be connected to a container that holds milk;
An air hose (16) that is linked to said intake chamber (3) and that has an opening (22) through which ambient air is designed to be drawn in;
An emulsion chamber (4) that has an outlet (7) through which the formed emulsion is evacuated; and
An air control (25) that is suitable for regulating the air flow circulating in the air hose (16),
characterized in that it comprises a tubular portion (14) that has an outside surface (24) in which is arranged the opening (22) of the air hose (16), the air control (25) comprises the first sealing means (29) and second sealing means (30) that are arranged on the outside surface (24) of the tubular portion (14), and said air control (25) can be moved between one position, said cappuccino position, for which the opening (22) of the air hose (16) communicates with the atmosphere, and one position, called hot milk position, for which the first sealing means (29) and second sealing means (30) define an airtight space in which the opening (22) of the air hose (16) is arranged.

2. Device according to claim 1, wherein at least the second sealing means (30) is integral with the air control (25) and moved with the latter.

3. Device according to claim 2, wherein the opening (22) of the air hose (16) comprises a calibrated groove (22a) that extends on both sides of the second sealing means (30) when the air control (25) is in cappuccino position, and included in the airtight space when the air control (25) is in hot milk position.

4. Device according to claim 3, wherein the calibrated groove (22a) has a cross-section increasing toward the air hose (16), whereby the air control (25) is suitable for taking at least a first and a second cappuccino position for which the second sealing means (30) is respectively positioned at a first and a second cross-section of the groove (22a), whereby said second section has an area that is greater than the first section.

5. Device according to claim 1, wherein the outside surface (24) of the tubular portion (14) is cylindrical, and the air control (25) is a ring that is mounted to rotate around the longitudinal axis (Y) of said tubular portion.

6. Device according to claim 5, wherein the air control (25) rotates at most 180° between its cappuccino position and its hot milk position.

7. Device according to claim 5, wherein the second sealing means (30) extends in an inclined plane relative to the longitudinal axis (Y) of the tubular portion (14) and wherein the air control (25) is guided in rotation relative to the tubular portion (14).

8. Device according to claim 5, wherein the second sealing means (30) extends in a plane that is transverse to the longitudinal axis (Y) of the tubular portion (14), and wherein the air control (25) is guided in a helical movement relative to the tubular portion (14).

9. Device according to claim 1, wherein at least one of the first sealing means (29) and second sealing means (30) is an annular collar that is made of the same material as the air control (25).

10. Espresso-type coffeemaker (55) that comprises a steam generator (56) and a tube (57) that has a first end that is connected to the steam generator (56) and a second end that forms a steam discharge, wherein a milk emulsion production device (1) according to claim 1 is arranged at the second end of the steam discharge tube (57).

11. Device according to claim 2, wherein the outside surface (24) of the tubular portion (14) is cylindrical, and the air control (25) is a ring that is mounted to rotate around the longitudinal axis (Y) of said tubular portion.

12. Device according to claim 6, wherein the second sealing means (30) extends in an inclined plane relative to the longitudinal axis (Y) of the tubular portion (14) and wherein the air control (25) is guided in rotation relative to the tubular portion (14).

13. Device according to claim 6, wherein the second sealing means (30) extends in a plane that is transverse to the longitudinal axis (Y) of the tubular portion (14), and wherein the air control (25) is guided in a helical movement relative to the tubular portion (14).
